(19) United States
(12) Patent Application Publication
(10) Pub. No.: US 2020/0108731 A1
(43) Pub. Date: Apr. 9, 2020

(54) CONTROL DEVICE AND CONTROL METHOD

(71) Applicant: DENSO TEN Limited, Kobe-shi (JP)

(72) Inventor: Hiroshi MATSUMOTO, Kobe-shi (JP)

(73) Assignee: DENSO TEN Limited, Kobe-shi (JP)

(21) Appl. No.: 16/550,427

(22) Filed: Aug. 26, 2019

(30) Foreign Application Priority Data
Oct. 5, 2018 (JP) 2018-190191

(51) Int. Cl. B60L 58/12; B60L 53/20

(52) U.S. Cl. CPC B60L 58/12; H02P 27/06; B60L 53/20

(57) ABSTRACT

A control device according to an embodiment includes a detection unit and a permission unit. The detection unit detects an operating state of an electronic component that is connected to a main battery through a power source relay that is provided between the main battery and an auxiliary machinery battery of a vehicle. The permission unit permits an opening or closing operation of the power source relay in a case where the operating state that is detected by the detection unit is a stopped state.

### CROSS-REFERENCE TO RELATED APPLICATION(S)

This application is based upon and claims the benefit of priority to Japanese Patent Application No. 2018-190191 filed on Oct. 5, 2018, the entire contents of which are herein incorporated by reference.

### FIELD

A disclosed embodiment relates to a control device and a control method.

### BACKGROUND

Conventionally, a control device is provided that executes supplying power from a main battery to an auxiliary machinery battery through a DCDC converter at a time of decreasing of a battery voltage of the auxiliary machinery battery that is mounted on a vehicle (see, for example, Japanese Patent Application Publication No. 2011-000894)

Such a type of control device opens or closes a relay that connects a main battery and an auxiliary machinery battery and operates a power converter, so that it is possible to execute supplying power from the main battery to the auxiliary machinery battery.

However, in a conventional technique, for example, an opening or closing operation of a relay may be executed during an operation of a DCDC converter, and in such a case, arc discharge may occur to cause breakage of the relay.

### SUMMARY

A control device according to an aspect of an embodiment includes a detection unit and a permission unit. The detection unit detects an operating state of an electronic component that is connected to a main battery through a power source relay that is provided between the main battery and an auxiliary machinery battery of a vehicle. The permission unit permits an opening or closing operation of the power source relay in a case where the operating state that is detected by the detection unit is a stopped state.

### BRIEF DESCRIPTION OF DRAWING(S)

More complete recognition of the present invention or advantage involved therewith could readily be understood by reading a following detailed description of the invention in light of the accompanying drawing(s).

FIG. 1 is a diagram illustrating an outline of a control method.

FIG. 2 is a block diagram of a control system.

FIG. 3 is a block diagram of a control device.

FIG. 4 to FIG. 6 are flowcharts illustrating process steps that are executed by a control device.

### DESCRIPTION OF EMBODIMENT(S)

Hereinafter, a control device and a control method according to an embodiment(s) will be explained in detail with reference to the accompanying drawing(s). Additionally, this invention is not limited by the present embodiment(s).

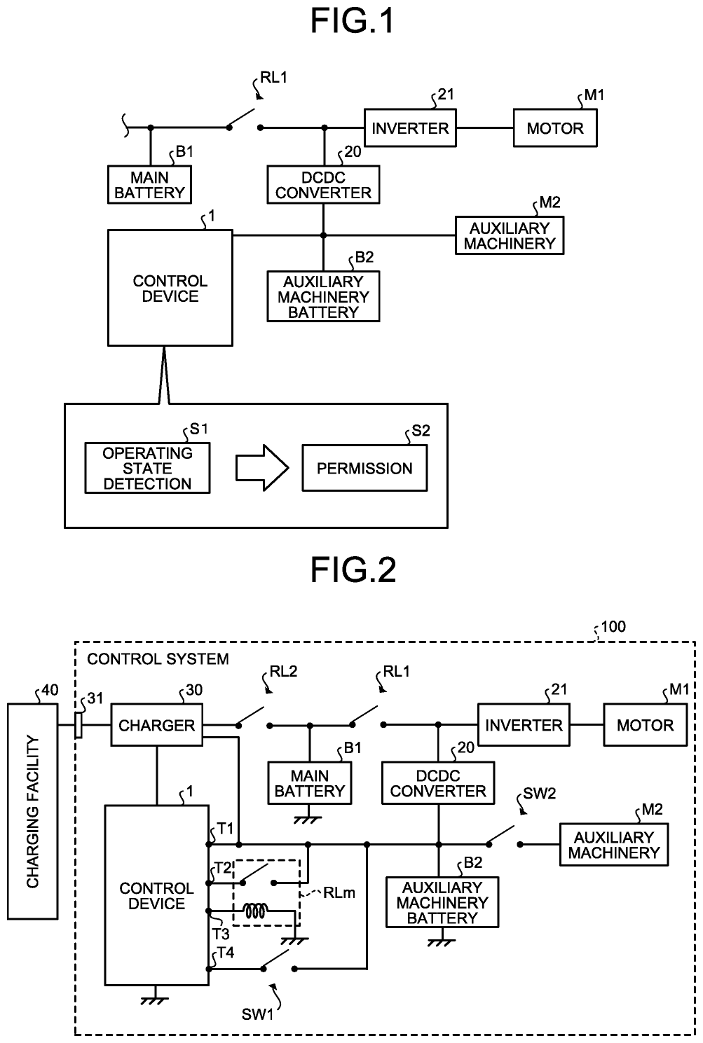

First, an outline of a control method according to an embodiment will be explained by using FIG. 1. FIG. 1 is a diagram illustrating an outline of a control method. Additionally, such a control method is executed by a control device 1 as illustrated in FIG. 1. Furthermore, FIG. 1 describes only a component that is needed for explanation, and simplifies and illustrates each relation of connection or the like, for ease of explanation.

The control device 1 as illustrated in FIG. 1 is a control device that controls charging of a main battery B1 or an auxiliary machinery battery B2 of a vehicle. The main battery B1 is a secondary battery that supplies power to a motor M1 that thrusts a vehicle, through an inverter 21, and the auxiliary machinery battery B2 is a secondary battery that supplies power to an auxiliary machinery M2 of a vehicle.

Furthermore, a power source relay RL1 and a DCDC converter 20 are provided between the main battery B1 and the auxiliary machinery battery B2. Additionally, the DCDC converter 20 and the inverter 21 are examples of an electronic component.

The control device 1 monitors each of battery voltages of the main battery B1 and the auxiliary machinery battery B2, and in a case where a battery voltage of the auxiliary machinery battery B2 is decreased, operates the DCDC converter 20 and connects the power source relay RL1, so that it is possible to charge the auxiliary machinery battery B2.

Herein, as the power source relay RL1 is opened or closed during operations of the DCDC converter 20 and the inverter 21, arc discharge may occur in the power source relay RL1 to cause breakage of the power source relay RL1.

Hence, in a control method according to an embodiment, in a case where an operating state of an electronic component is detected and such an operating state of an electronic component is a stopped state, opening or closing of the power source relay RL1 is permitted.

Specifically, the control device 1 detects operating states of the DCDC converter 20 and the inverter 21 that are connected to the power source relay RL1 (step S1). For example, the control device 1 detects a control signal that controls the DCDC converter 20 and the inverter 21, so that it is possible to detect operating states of the DCDC converter 20 and the inverter 21.

Subsequently, in a case where each of operating states of the DCDC converter 20 and the inverter 21 is a stopped state, the control device 1 permits opening or closing of the power source relay RL1 (step S2).

Specifically, in a case where supplying power to the auxiliary machinery battery B2 is started and in a case where both the DCDC converter 20 and the inverter 21 are stopped states, the control device 1 connects the power source relay RL1, and afterward, permits activation of the DCDC converter 20.

Furthermore, in a case where charging of the auxiliary machinery battery B2 is stopped and in a case where both the DCDC converter 20 and the inverter 21 are stopped states, the control device 1 permits connection release of the power source relay RL1.

Similarly, the control device 1 permits connection of the power source relay RL1 in a case where the motor M1 is driven by using power of the main battery B1 and in a case where the DCDC converter 20 and the inverter 21 are provided in stopped states, or permits connection release of the power source relay RL1 in a case where the motor M1 is stopped and in a case where the DCDC converter 20 and the inverter 21 are provided in stopped states.

Thus, in a control method according to an embodiment, in a case where an electronic component that is connected to the power source relay RL1 is provided in a stopped state, opening or closing of the power source relay RL1 is permitted, so that it is possible to attain component protection of the power source relay RL1.

Next, a configuration example of a control system 100 that includes a control device 1 will be explained by using FIG. 2. FIG. 2 is a block diagram of the control system 100. Additionally, in FIG. 2, the control device 1 is simplified and a charging facility 40 is illustrated together.

As illustrated in FIG. 2, the control system 100 includes the control device 1, a main battery B1, an auxiliary machinery battery B2, a DCDC converter 20, and an inverter 21, a charger 30, a motor M1, and an auxiliary machinery M2.

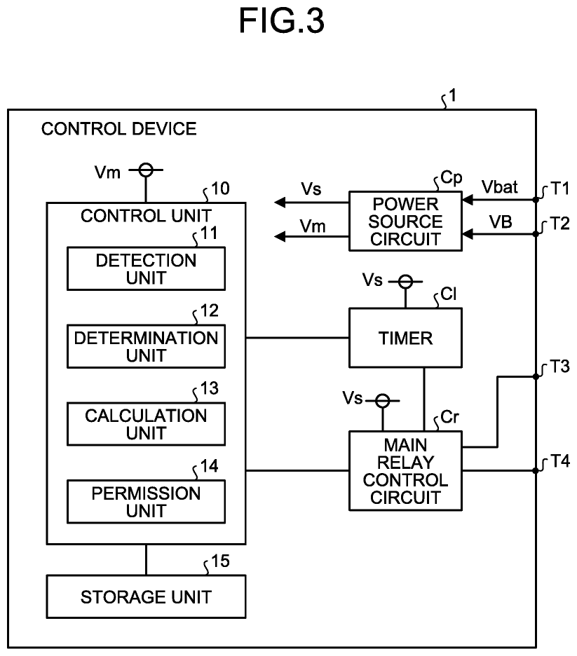

The control device 1 includes an Electronic Control Unit (ECU) that controls a whole of the control system 100 and a variety of circuits for supplying a power source to such an ECU. Additionally, a configuration example of the control device 1 will be described later by using FIG. 3.

The main battery B1 is a storage battery with a higher resistance to instantaneous large current discharge than the auxiliary machinery battery B2 and a lower charging/discharging efficiency than the auxiliary machinery battery B2, and is, for example, a lead battery.

The auxiliary machinery battery B2 is a storage battery with a lower resistance to instantaneous large current discharge than the main battery B1 and a higher charging/discharging efficiency than the main battery B1, and is, for example, a lithium ion battery or capacitor or the like.

The auxiliary machinery battery B2 is connected to the auxiliary machinery M2 through an accessory switch SW2 and supplies power to the auxiliary machinery M2. Furthermore, the auxiliary machinery battery B2 is connected to the control device 1 through a terminal T1 or a main relay RLm, and a terminal T2, so that it is also possible to supply power to the control device 1.

Furthermore, the auxiliary machinery battery B2 is connected to the control device 1 through a vehicle starting switch SW1 and a terminal T4. For example, the vehicle starting switch SW1 is a switch that is connected in a case where an ignition switch of a vehicle is turned on.

The DCDC converter 20 is provided between the main battery b1 and the auxiliary machinery battery B2, decreases an input voltage that is input from the main battery B1, by control of the control device 1, and supplies it to the auxiliary machinery battery B2 through a charging relay RL2.

The inverter 21 adjusts a power source frequency of an input voltage that is input from the main battery B1 and supplies it to the motor M1. Thereby, it is possible to adjust a rotational frequency of the motor M1.

The auxiliary machinery M2 is an on-vehicle device that consumes power constantly or continuously for a comparatively long period of time, and is, for example, a car navigation device, a television device, a radio device, an audio device, an air conditioning device, or the like that is provided on a vehicle.

The charger 30 adjusts power that is supplied from the charging facility 40 through a charging connector 31 to a predetermined voltage, and afterward, supplies it to the main battery B1 or the auxiliary machinery battery B2.

In a case where the charging connector 31 is connected to the charging facility 40, the charger 30 outputs, to the control device 1, a connection request of the charging relay RL2 that is provided between the charger 30 and the main battery B1. Thereby, it is possible to charge the main battery B1 by power that is supplied from the charging facility 40.

Next, a configuration example of a control device 1 will be explained by using FIG. 3. FIG. 3 is a block diagram of the control device 1. As illustrated in FIG. 3, the control device 1 includes a control unit 10, a storage unit 15, a power source circuit Cp, a timer Cl, and a main relay control circuit Cr.

The power source circuit Cp is composed of a variety of circuits such as a transformation circuit or a stabilization circuit and adjusts a voltage that is input from the auxiliary machinery battery B2. The power source circuit Cp decreases an input voltage Vbat that is input from the auxiliary machinery battery B2 through a terminal T1 to a predetermined voltage and outputs it as an output voltage Vs.

Furthermore, it is possible for the power source circuit Cp to decrease an input voltage VB that is input from the auxiliary machinery battery B2 through the main relay RLm (see FIG. 2) and a terminal T2 to a predetermined voltage and output it as an output voltage Vm.

Additionally, an input voltage Vbat is always input to the power source circuit Cp and an input voltage VB is input thereto only for a period of time when the main relay RLm is turned on.

The timer Cl activates the control unit 10 at a predetermined cycle for a period of time when an ignition switch of a vehicle is turned off. The timer Cl starts counting for a period of time when an ignition switch is turned off, and in a case where a predetermined threshold time is reached, outputs a connection request signal of the main relay RLm to the main relay control circuit Cr.

Thereby, the main relay RLm is connected by the main relay control circuit Cr, so that an input voltage VB is input to the power source circuit Cp. Furthermore, the control unit 10 operates at an output voltage Vm that is based on an input voltage VB, and thereby, the timer Cl connects the main relay RLm, so that it is possible to activate the control unit 10.

The main relay control circuit Cr is a circuit that controls opening or closing of the main relay RLm. It is possible for the main relay control circuit Cr to control opening or closing of the main relay RLm depending on a control signal of the control unit 10 or a connection request signal that is output from the timer Cl as described above.

The control unit 10 is activated at a predetermined cycle based on an operation of the timer Cl for a period of time when ignition of a vehicle is turned off.

The control unit 10 includes a detection unit 11, a determination unit 12, a calculation unit 13, and a permission unit 14. The control unit 10 includes, for example, a computer that has a Central Processing Unit (CPU), a Read Only Memory (ROM), a Random Access Memory (RAM), a Hard Disk Drive (HDD), an input/output port, and the like, and a variety of circuits.

A CPU of a computer reads and executes, for example, a program that is stored in a ROM, and thereby, functions as the detection unit 11, the determination unit 12, the calculation unit 13, and the permission unit 14 of the control unit 10.

Furthermore, it is also possible to provide at least one or all of the detection unit 11, the determination unit 12, the calculation unit 13, and the permission unit 14 of the control unit 10 that are composed of hardware such as an Application Specific Integrated Circuit (ASIC) or a Field Programmable Gate Array (FPGA).

Furthermore, the storage unit 15 corresponds to, for example, a RAM or a data flush. It is possible for a RAM or a data flush to store a variety of data or information of a variety of programs. Additionally, the control device 1 may acquire a program as described above or a variety of information through another computer that is connected by a wired or wireless network or a portable recording medium.

The detection unit 11 detects an operating state of an electrical component that is connected to the main battery B1 through the power source relay RL1 that is provided between the main battery B1 and the auxiliary machinery battery B2. Additionally, the DCDC converter 20 and the inverter 21 as described above correspond to electrical components.

For example, the detection unit 11 detects a control signal that is input to each electrical component, so that it is possible to detect an operating state of each electrical component. As an operating state of each electrical component is detected, the detection unit 11 executes writing an activation flag into the storage unit 15. For example, for an activation flag, “1” indicates activation and “0” indicates stopping.

The determination unit 12 is activated at a predetermined cycle for a period of time when a vehicle is stopped, that is, a period of time when an ignition switch of a vehicle is turned off, so that determination of fixation of the power source relay RL1 is executed. Specifically, the determination unit 12 is activated at a predetermined cycle by the timer Cl as described above and executes determination of fixation of the power source relay RL1 at a time of activation thereof.

It is possible for the determination unit 12 to execute determination of fixation based on a result of measurement of a (non-illustrated) voltmeter that is provided between the power source relay RL1 and the DCDC converter 20. That is, it is possible for the determination unit 12 to determine that the power source relay RL1 is closed and fixed, in a case where a voltage value exceeds a predetermined voltage value, for a period of time when a command value to the power source relay RL1 is OFF.

On the other hand, in a case as described above and in a case where a value of a voltmeter is 0, it is possible for the determination unit 12 to determine that the power source relay RL1 is normal. Then, the determination unit 12 executes writing of a result of determination into the storage unit 15.

The calculation unit 13 calculates a battery states (States of Charge (SOC)) of the main battery B1 and the auxiliary machinery battery B2. Specifically, as the control unit 10 is activated, the calculation unit 13 calculates SOCs of the main battery B1 and the auxiliary machinery battery B2 in a case where a predetermined condition is satisfied.

Herein, a predetermined condition indicates that an operating state of each electrical component that is detected by the detection unit 11 is a stopped state and a result of determination that is provided by the determination unit 12 is not closed or fixed. The calculation unit 13 refers to information that is written into the storage unit 15 by the detection unit 11 and the determination unit 12, so that it is possible to determine whether or not a predetermined condition is satisfied.

Subsequently, in a case where a predetermined condition is satisfied, the calculation unit 13 acquires a battery voltage of each of the main battery B1 and the auxiliary machinery battery B2. Herein, in a case where a predetermined condition is satisfied, a battery voltage of each of the main battery B1 and the auxiliary machinery battery B2 corresponds to an open voltage (Open Circuit Voltage (OCV)).

Then, it is possible for the calculation unit 13 to calculate an SOC of each of the main battery B1 and the auxiliary machinery battery B2 based on an SOC-OCV curve that indicates a relationship between an SOC and an OCV in each of the main battery B1 and the auxiliary machinery battery B2.

Thus, the calculation unit 13 calculates an SOC in a case where a predetermined condition as described above is satisfied, so that it is possible to calculate each SOC accurately. Then, the calculation unit 13 notifies the permission unit 14 of a charging request from the main battery B1 to the auxiliary machinery battery B2 in a case where an SOC of the main battery B1 is greater than or equal to a first threshold and an SOC of the auxiliary machinery battery B2 is less than or equal to a second threshold, or notifies the permission unit 14 of a charging stop request to the auxiliary machinery battery B2 in a case where an SOC of the auxiliary machinery battery B2 reaches the second threshold.

The permission unit 14 permits an opening or closing operation of the power source relay RL1 in a case where an operating state of the power source relay RL1 that is detected by the detection unit 11 is a stopped state. Specifically, in a case where a charging request as described above is acquired and in a case where each of the DCDC converter 20 and the inverter 21 is provided in a stopped state, the permission unit 14 permits connection of the power source relay RL1, connects the power source relay RL1, and afterward, permits an operation of the DCDC converter 20.

Thereby, power is supplied from the main battery B1 to the auxiliary machinery battery B2 through the DCDC converter 20. Afterward, in a case where a charging stop request is acquired from the calculation unit 13, the permission unit 14 permits connection release of the power source relay RL1 after the DCDC converter 20 is stopped.

Furthermore, in a case where a starting request or a stopping request of the motor M1 is acquired and in a case where each of the DCDC converter 20 and the inverter 21 is provided in a stopped state, it is also possible for the permission unit 14 to permit an opening or closing operation of the power source relay RL1.

Specifically, in a case where a starting request is acquired and in a case where each of the DCDC converter 20 and the inverter 21 is provided in a stopped state, the permission unit 14 permits connection of the power source relay RL1, and afterward, permits driving of the inverter 21.

Furthermore, in a case where a stopping request is acquired, the permission unit 14 stops the inverter 21, and afterward, permits connection release of the power source relay RL1.

Thus, the permission unit 14 permits an opening or closing operation of the power source relay RL1 only for a period of time when the DCDC converter 20 or the inverter 21 is stopped, so that it is possible to suppress occurrence of arc discharge in the power source relay R11 and hence it is possible to attain component protection of the power source relay RL1.

Meanwhile, a starting request of the motor M1 may be received during charging of the auxiliary machinery battery B2. In such a case, it is possible for the permission unit 14 to permit an operation of the inverter 21 while the power source relay RL1 is connected.

Specifically, for example, the permission unit 14 operates the inverter 21 while the power source relay RL1 is connected, so that power is supplied from the main battery B1 to the motor M1.

In such a case, if connection or disconnection is executed for the power source relay RL1, starting of the motor M1 is delayed by a period of time that is needed for such connection or disconnection.

On the contrary, the permission unit 14 connects the power source relay RL1, so that it is possible to start the motor M1 quickly.

Next, a process of the permission unit 14 at a time when the main battery B1 and the auxiliary machinery battery B2 are charged through the charger 30 as illustrated in FIG. 2 will be explained. The charger 30 notifies the control unit 10 of a charging request signal in a case where a non-illustrated charging plug is connected to the charging facility 40.

In a case where a charging request signal is acquired, the permission unit 14 connects the charging relay RL2, so that the main battery B1 is charged from the charger 30 through the charging relay PL2.

Furthermore, in a case where a charging end condition is satisfied, the permission unit 14 permits connection release of the charging relay RL2, so that it is possible to stop charging of the main battery B1.

Herein, a charging end condition is, for example, either a condition that an SOC of the main battery B1 is greater than or equal to a predetermined value or a condition that an SOC of the auxiliary machinery battery B2 is less than a predetermined value.

Thus, in a case where a charging request signal is acquired, the permission unit 14 connects the charging relay RL2, so that it is possible to charge the main battery B1 by power that is supplied from the charging facility 40. Thereby, it is possible to suppress buttery running out of the main battery B1.

Additionally, in a case where the determination unit 12 determines that the power source relay RL1 is closed and fixed, it is also possible for the permission unit 14 to forbid an operation of the DCDC converter 20. In other words, it is possible to forbid supplying power from the main battery B1 to the auxiliary machinery battery B2.

Thereby, it is possible to suppress decreasing of a remaining battery level of the main battery B1 and it is possible to suppress battery running out.

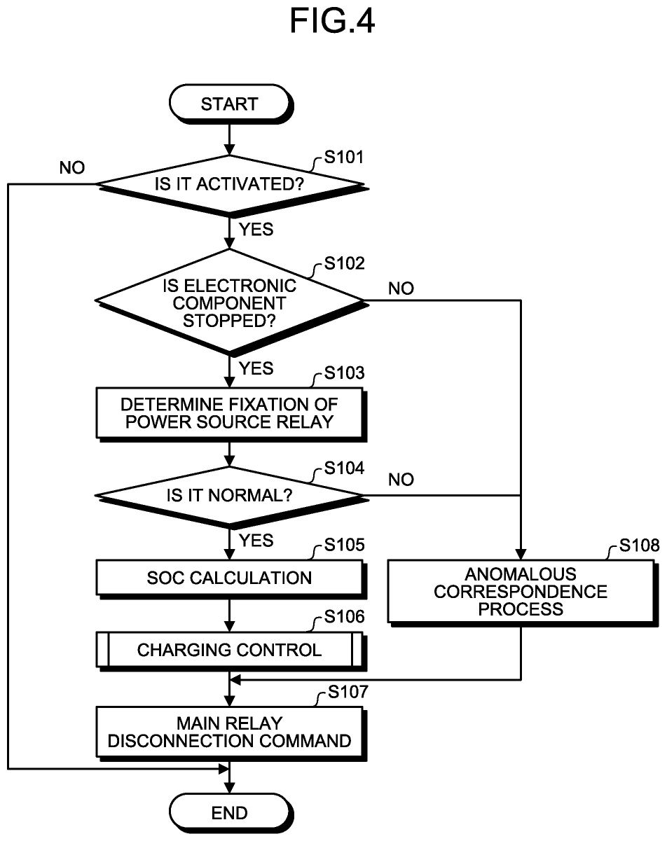

Next, process steps that are executed by the control device 1 according to an embodiment will be explained by using FIG. 4 to FIG. 6. FIG. 4 to FIG. 6 are flowcharts illustrating process steps that are executed by the control device 1.

First, a series of processes of the control unit 10 of the control device 1 for a period of time when an ignition switch of a vehicle is turned off will be explained by using FIG. 4. As illustrated in FIG. 4, first, the control unit 10 determines whether or not the control unit 10, per se, is activated by the timer Cl (step S101).

In a case where it is determined that the control unit 10, per se, is activated based on the timer Cl (step S101, Yes), the control unit 10 determines whether or not an electronic component is stopped (step S102). Herein, in a case where an electronic component is stopped (step S102, Yes), the control unit 10 executes determination of fixation of the power source relay RL1 (step S103).

Subsequently, the control unit 10 determines whether or not the power source relay RL1 is normal as a result of determination of fixation (step S104), and in a case where the power source relay RL1 is normal, calculates SOCs of the main battery B1 and the auxiliary machinery battery B2 (step S105).

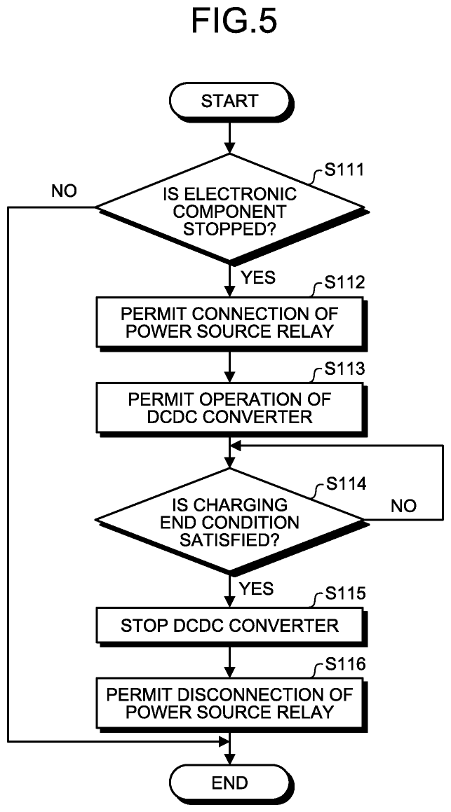

Afterward, the control unit 10 executes charging control for the auxiliary machinery battery B2 based on an SOC that is calculated at step S105 (step S106), outputs a disconnection command for the main relay RLm to the main relay control circuit Cr (step S107), and ends such a process. Additionally, charging control at step S106 will be explained by using FIG. 5.

Furthermore, in a case where the control unit 10, per se, is not activated in a process at step S101 (step S101, No), the control unit 10 ends such a process directly. Furthermore, in a case where an electronic component is operated in a process at step S102 (step S102, No) or in a case where the power source relay RL1 is closed and fixed in a process at step S104 (step S104, No), the control unit 10 executes an anomalous correspondence process (step S108) and ends such a process. Additionally, an anomalous correspondence process herein includes, for example, a diagnosis output or the like.

Next, process steps of a charging control process at step S107 will be explained by using FIG. 5. As illustrated in FIG. 5, first, the control unit 10 determines whether or not an electronic component is stopped (step S111).

In a case where an electronic component is stopped (step S111, Yes), the control unit 10 permits connection of the power source relay RL1 (step S112), and afterward, permits an operation of the DCDC converter 20 (step S113).

The control unit 10 determines whether or not a charging end condition is satisfied (step S114), and in a case where such a charging end condition is satisfied (step S114, Yes), stops the DCDC converter 20 (step S115), afterward permits disconnection of the power source relay RL1 (step S116), and ends such a process.

Furthermore, in a case where an electronic component is not provided in a stopped state in a process at step S111 (step S111, No), the control unit 10 ends such a process. Additionally, herein, the control unit 10 may stop an electronic component and afterward transfer to a process at step S112.

Furthermore, in a case where a charging end condition is not satisfied in a process at step S114 (step S114, No), the control unit 10 continuously executes a process at step S114.

Additionally, although a process of the control unit 10 in a case where the DCDC converter 20 is operated has been explained herein, it is also possible to apply such a process step to a process of operating the inverter 21.

In such a case, it is sufficient that the DCDC converter 20 as illustrated in FIG. 5 is replaced with the inverter 21 and “a charging end condition being satisfied” at step S114 is replaced with “acquiring a stopping request of the motor M1”.

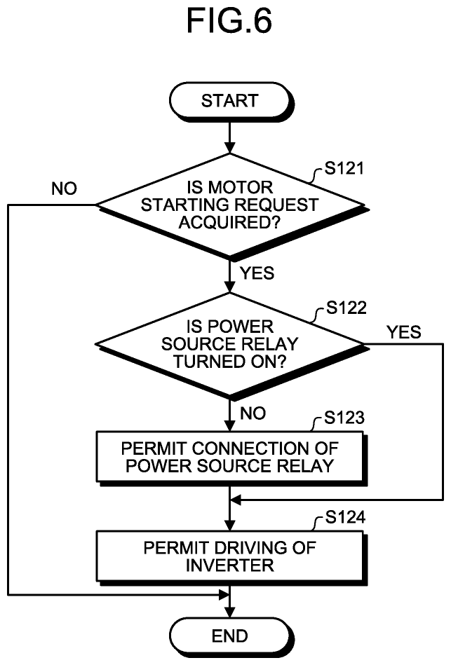

Next, a process of the control unit 10 at a time when the inverter 21 is driven will be explained by using FIG. 6. As illustrated in FIG. 6, the control unit 10 determines whether or not a starting request of the motor M1 is acquired (step S121).

In a case where a starting request of the motor M1 is acquired (step S121, Yes), the control unit 10 determines whether or not the power source relay L1 is tuned on (step S122). In a case where the power source relay RL1 is turned off and the power source relay RL1 is not closed and fixed (step S122, No), the control unit 10 permits connection of the power source relay RL1 (step S123).

Then, the control unit 10 permits driving of the inverter 21 (step S124) and ends such a process. Furthermore, in a case where the power source relay RL1 is tuned on in a process at step S122 (step S122, Yes), the control unit 10 omits a process at step S123 and transfers to a process at step S124.

As described above, the control device 1 according to an embodiment includes the detection unit 11 and the permission unit 14. The detection unit 11 detects an operating state of an electrical component that is connected to the main battery B1 through the power source relay RL1 that is provided between the main battery B1 and the auxiliary machinery battery B2 of a vehicle.

The permission unit 14 permits an opening or closing operation of the power source relay RL1 in a case where an operating state that is detected by the detection unit 11 is a stopped state. Therefore, it is possible for the control device 1 according to an embodiment to execute component protection.

According to the present invention, it is possible to attain component protection.

An additional effect or variation can readily be derived by a person(s) skilled in the art. Hence, a broader aspect(s) of the present invention is/are not limited to a specific detail(s) and a representative embodiment(s) as illustrated and described above. Therefore, various modifications are possible without deviating from the spirit or scope of a general inventive concept that is defined by the appended claim(s) and an equivalent(s) thereof.

What is claimed is:

1. A control device, comprising:
a detection unit that detects an operating state of an electronic component that is connected to a main battery through a power source relay that is provided between the main battery and an auxiliary machinery battery of a vehicle; and
a permission unit that permits an opening or closing operation of the power source relay in a case where the operating state that is detected by the detection unit is a stopped state.

2. The control device according to claim 1, comprising:
a determination unit that is activated at a predetermined cycle for a period of time when an ignition switch of a vehicle is turned off and executes determination of fixation of the power source relay; and
a calculation unit that calculates battery states of the main battery and the auxiliary machinery battery in a case where the determination unit determines that the power source relay is not fixed and the operating state that is detected by the detection unit is a stopped state.

3. The control device according to claim 2, wherein
the auxiliary machinery battery is connected to the power source relay through a DCDC converter, and
the permission unit forbids an operation of the DCDC converter in a case where the determination unit determines that the power source relay is fixed.

4. The control device according to claim 1, wherein
the permission unit permits an operation of a motor that causes the vehicle to run while connecting the power source relay in a case where a running request for the vehicle is provided from the main battery to the auxiliary machinery battery through the power source relay during charging thereof.

5. The control device according to claim 2, wherein
the permission unit permits an operation of a motor that causes the vehicle to run while connecting the power source relay in a case where a running request for the vehicle is provided from the main battery to the auxiliary machinery battery through the power source relay during charging thereof.

6. The control device according to claim 3, wherein
the permission unit permits an operation of a motor that causes the vehicle to run while connecting the power source relay in a case where a running request for the vehicle is provided from the main battery to the auxiliary machinery battery through the power source relay during charging thereof.

7. A control method, comprising:
a detection step that detects an operating state of an electronic component that is connected to a main battery through a power source relay that is provided between the main battery and an auxiliary machinery battery of a vehicle; and
a permission step that permits an opening or closing operation of the power source relay in a case where the operating state that is detected by the detection step is a stopped state.
